(19) United States
(12) Patent Application Publication
(10) Pub. No.: US 2012/0103870 A1
(43) Pub. Date: May 3, 2012

(54) FLUID CATALYTIC CRACKING CATALYST STRIPPING

(75) Inventors: John Scott Buchanan, Lambertville, NJ (US); Steven S. Lowenthal, Flanders, NJ (US); George A. Swan, III, Baton Rouge, LA (US); James O. Guerra, Houston, TX (US)

(73) Assignee: EXXONMOBIL RESEARCH AND ENGINEERING COMPANY, Annandale, NJ (US)

(21) Appl. No.: 13/281,903

(22) Filed: Oct. 26, 2011

Related U.S. Application Data
(60) Provisional application No. 61/409,386, filed on Nov. 2, 2010.

(51) Int. Cl. C10G 11/00; B01J 8/00

(52) U.S. Cl. 208/113; 422/187

(57) ABSTRACT

This disclosure relates to devices, e.g., baffle plate and combination dipleg valve/baffle devices, for use in achieving rapid disengagement of entrained hydrocarbons vapors, especially in high flux spent catalyst flow exiting from a cyclone separator dipleg in a fluidized catalytic cracking (FCC) unit. The baffle plate is preferably located near and typically below the catalyst dipleg of a fluid catalytic cracking reactor or separation zone and comprises a baffle plate body member having a surface, and in preferred embodiments also includes one or more apertures located on at least a portion of the surface. The valve/baffle is located at the outlet of the catalyst dipleg and comprises a combination valve and catalyst baffle in which the valve/baffle is designed to allow the top surface of the valve/baffle to seat against the dipleg outlet until the weight of the catalyst above the valve/baffle forces it to open. This disclosure also relates to FCC units that include the devices, and FCC methods utilizing the devices.

This application claims benefit of U.S. Provisional Application 61/409,386 filed Nov. 2, 2010, which is incorporated by reference in its entirety herein.

### FIELD OF INVENTION

This disclosure relates to devices, e.g., splash baffles and valve/baffle devices, for use in achieving rapid disengagement of entrained hydrocarbon vapors, especially in high flux spent catalyst flow exiting from a cyclone separator dipleg in a fluidized catalytic cracking (FCC) unit. This disclosure also relates to FCC units including these devices, and to FCC methods utilizing these devices.

### BACKGROUND

A variety of processes contact finely divided particulate material with a hydrocarbon containing feed under conditions wherein a fluid maintains the particles in a fluidized condition to effect transport of the solid particles to different stages of the process. An FCC process is an example of such a process that contacts hydrocarbons in a reaction zone with a catalyst composed of finely divided particulate material.

An FCC unit typically comprises a reaction zone and a catalyst regeneration zone. In the reaction zone, a feed stream is contacted with finely divided fluidized solid particles or catalyst maintained at an elevated temperature and at a moderate positive pressure. In modern FCC units, contacting of feed and catalyst usually takes place in a riser conduit under short contact time conditions, but other effective arrangements may also be used. In the case of a riser reactor, a principally vertical conduit comprises the main reaction site, with the effluent of the conduit emptying into a large volume process vessel, which is typically called the reactor vessel or may be referred to as a separation vessel. The residence time of catalyst and hydrocarbons in the riser needed for substantial completion of the cracking reactions is only a few seconds or less.

The flowing hydrocarbon vapor/catalyst stream leaving the riser may pass from the riser to one or more solids-vapor separation devices located within the separation vessel or may enter the separation vessel directly without passing through an intermediate separation apparatus. When no intermediate apparatus is provided, much of the catalyst drops out of the flowing hydrocarbon vapor/catalyst stream as the stream leaves the riser and enters the reactor vessel. One or more additional solids/vapor separation devices, almost invariably a cyclone separator, are normally located within and near the top of the large reactor vessel. The products of the reaction are separated from a portion of catalyst, which is still carried by the vapor stream, by means of the cyclone or cyclones and the hydrocarbon vapor is vented from the cyclone and separation vessel. The spent catalyst falls downward to a lower location within the separation vessel. As used herein, the term “spent catalyst” is intended to indicate catalyst employed in the reaction zone that is being transferred to the regeneration zone for the removal of coke deposits. The term is not intended to be indicative of a total lack of catalytic activity by the catalyst particles. The term “used catalyst” is intended to have the same meaning as the term “spent catalyst”.

Catalyst is continuously circulated from the reaction zone to the regeneration zone and then again to the reaction zone. The catalyst therefore acts as a vehicle for the transfer of heat from zone to zone as well as providing the necessary catalytic activity. The catalyst particles will typically have an average size of less than 100 microns. Catalyst which is being withdrawn from the regeneration zone is referred to as “regenerated” catalyst. The catalyst charged to the regeneration zone is brought into contact with an oxygen-containing gas such as air or oxygen-enriched air under conditions which result in combustion of the coke. This results in an increase in the temperature of the catalyst and the generation of a large amount of hot gas which is removed from the regeneration zone as a gas stream referred to as a flue gas stream. The regeneration zone is normally operated at a temperature of from about 600° C. to about 800° C.

A majority of the hydrocarbon vapors that contact the catalyst in the reaction zone are separated from the solid particles by ballistic and/or centrifugal separation methods within the reaction zone. These separation methods (including the cyclones and associated cyclone diplegs) are typically located in what is termed the “dilute phase” of the reactor. The catalyst particles employed in a. FCC process have a large surface area, which is due to a great multitude of pores located in the particles. As a result, the catalytic materials retain hydrocarbons within their pores, upon the external surface of the catalyst and in the spaces between individual catalyst particles, as they enter the stripping zone. Although the quantity of hydrocarbons retained on each individual catalyst particle is very small, the large amount of catalyst and the high catalyst circulation rate which is typically used in a modern FCC process results in a significant quantity of hydrocarbons being withdrawn from the reaction zone with the catalyst. It is generally undesirable to have hydrocarbons remaining on the catalyst when the catalyst is sent to the regeneration zone. In particular, it is undesirable to have the valuable lighter, or gasoline/naphtha, range hydrocarbons remaining on the catalyst that leaves the reactor vessel and is sent to the regeneration zone, as these hydrocarbons are lost (i.e., combusted) in the regeneration process instead of being recovered from the FCC reactor as valuable liquid fuels.

Therefore, it is common practice to remove, or strip, hydrocarbons from spent catalyst prior to passing the catalyst into the regeneration zone. Aside from the lost recover of valuable hydrocarbon products from the process, greater concentrations of hydrocarbons on the spent catalyst that enters the regenerator also increases the regenerator's relative carbon-burning load and result in hotter regenerator temperatures. Avoiding the unnecessary burning of hydrocarbons is especially important during the processing of heavy (relatively high molecular weight) feedstocks, since processing these feedstocks increases the deposition of coke on the catalyst during the reaction, in comparison to the coking rate with light feedstocks, and raises the temperature in the regeneration zone. Improved stripping permits cooler regenerator temperatures and higher conversion and product recovery.

The most common method of stripping the spent catalyst includes passing a stripping gas, usually steam, through a flowing stream of catalyst, counter-current to its direction of flow. Such steam stripping operations, with varying degrees of efficiency, remove a portion of the hydrocarbon which are entrained within the catalyst and/or adsorbed on the catalyst. Most FCC reactors include a stripping section, which is generally located in a section of the reactor wherein the cross-section (i.e., diameter) of the reactor is smaller than the disengaging section of the reactor wherein the cyclone and associated cyclone diplegs are located. This stripping section or “stripper” is typically located in the “dense phase” section of the reactor vessel comprised of a series of baffles to increase contacting of the stripping gas and spent catalyst before removing the catalyst from the reactor for regeneration.

However, these conventional methods for stripping hydrocarbons from the FCC catalyst are insufficient and result in a significant amount of valuable recoverable hydrocarbons that are lost in the process due to lack of sufficient hydrocarbon stripping of the spent catalysts in these processes. A continuing need exists in the industry for improving spent catalyst stripping without experiencing any performance disadvantages of the overall FCC process. Improved spent catalyst stripping can avoid the unnecessary burning of hydrocarbons that is especially important during the processing of heavy (relatively high molecular weight) feedstocks, since processing these feedstocks increases the deposition of coke on the catalyst during the reaction, in comparison to the coking rate with light feedstocks, and raises the temperature in the regeneration zone. Improved spent catalyst stripping can permit cooler regenerator temperatures and higher recovery of valuable hydrocarbon products. Also, minimizing product hydrocarbon (fluidizing gas) entrainment with the high flux of spent catalyst exiting cyclone diplegs can avoid further non-selective conversion resulting from relatively long (e.g., 1-2 minutes) stripper residence time. This can improve overall FCC profitability.

The present disclosure provides many advantages, which shall become apparent as described below.

### SUMMARY OF THE DISCLOSURE

This disclosure relates in part to new apparatus of a fluid catalytic cracking unit and associated fluid catalytic cracking processes.

An embodiment disclosed herein is a fluid catalytic cracking unit comprising:

a riser conversion zone for passing a suspension of a hydrocarbon feed and a fluidized catalyst therethrough and cracking said hydrocarbon feed to produce a mixture, said mixture comprising converted products, unconverted hydrocarbon feed and spent catalyst;

at least one cyclone separator, in fluid connection with the riser conversion zone, for separating at least a portion of the spent catalyst from the mixture, said at least one cyclone separator having an inlet a gas phase outlet, and a solids outlet;

a dipleg comprising a dipleg inlet in fluid connection with the cyclone separator solids outlet, and a dipleg outlet;

a catalyst pre-stripping zone in fluid connection with the dipleg outlet for contacting a first stripping gas with the spent catalyst to remove at least a portion of hydrocarbons entrained within the catalyst;

at least one baffle plate located in the catalyst (pre-stripping zone near the dipleg outlet for dispersing spent catalyst flow from the dipleg;

a dense phase stripping zone, in fluid connection with the catalyst pre-stripping zone, for contacting a second stripping gas with the spent catalyst to remove hydrocarbons entrained within the spent catalyst; and

a regeneration zone, in fluid connection with the dense phase stripping zone, for regenerating the spent catalyst.

Another embodiment disclosed herein is a method of fluid catalytic cracking of a hydrocarbon feed comprising:

passing a suspension of a hydrocarbon feed and a fluidized catalyst through a riser conversion zone;

cracking said hydrocarbon feed in said riser conversion zone to produce a mixture, said mixture comprising converted products, unconverted hydrocarbon feed, and spent catalyst;

passing said mixture from the riser conversion zone to at least one cyclone separator having an inlet a gas phase outlet, and a solids outlet;

separating at least a portion of the spent catalyst from the mixture in said at least one cyclone separator;

passing the separated spent catalyst downwardly into a dipleg said dipleg having an inlet and an outlet, wherein said dipleg inlet is fluidly connected to said cyclone separator solids outlet;

passing the separated spent catalyst through the dipleg to the dipleg outlet located in a catalyst pre-stripping zone, said catalyst pre-stripping zone containing at least one baffle plate located near the dipleg outlet;

contacting at least a portion of said separated spent catalyst with said baffle plate thereby dispersing at least a portion of said separated spent catalyst contacting said baffle plate within said catalyst pre-stripping zone;

contacting said separated spent catalyst with a first stripping gas after contacting of said spent catalyst with said baffle plate in the catalyst pre stripping zone to remove at least a portion of hydrocarbons entrained within the separated spent catalyst;

passing the separated spent catalyst from the catalyst pre-stripping zone to a catalyst stripping zone;

contacting a second stripping gas with the separated spent catalyst in countercurrent flow in the catalyst stripping zone to remove hydrocarbons entrained within the catalyst; and

passing the separated spent catalyst from the catalyst stripping zone to a catalyst regeneration vessel,

In yet another embodiment disclosed herein is a fluid catalytic cracking unit comprising:

a riser conversion zone for passing a suspension of a hydrocarbon feed and a fluidized catalyst therethrough and cracking said hydrocarbon feed to produce a mixture, said mixture comprising converted products, unconverted hydrocarbon feed and spent catalyst;

at least one cyclone separator, in fluid connection with the riser conversion zone, for separating at least a portion of the spent catalyst from the mixture, said at least one cyclone separator having an inlet, a gas phase outlet, and a solids outlet;

a dipleg inlet in fluid connection with the cyclone separator solids outlet, and a dipleg outlet;

a dipleg valve/baffle in fluid communication with said dipleg outlet for controlling spent catalyst flow through the dipleg and dispersing said spent catalyst within a catalyst pre-stripping zone;

the catalyst pre-stripping zone in fluid connection the dipleg outlet for contacting a stripping gas with the spent catalyst to remove at least a portion of hydrocarbons entrained within the catalyst;

a dense phase stripping zone, in fluid connection with the catalyst pre-stripping zone, for contacting a stripping gas with the spent catalyst to remove hydrocarbons entrained within the spent catalyst; and

a regeneration zone, in fluid connection with the dense phase stripping zone, for regenerating the spent catalyst.

In a more preferred embodiment, encompasses the fluid catalytic cracking unit described prior wherein the dipleg valve/baffle comprises:

a valve/baffle body member comprising a having a conical or domed surface, said valve/baffle surface comprising a seating surface that is complementary to the seating surface of the dipleg outlet; and

a means for suspending the valve/baffle from the dipleg, thereby allowing a closed position and an open position; wherein, in the closed position, the valve/baffle seating surface is seated against the dipleg outlet seating surface, thereby substantially preventing gases from progressing upwardly through the dipleg; and wherein, in the open position, the valve/baffle seating surface is not seated against the dipleg outlet seating surface, thereby permitting spent catalyst to progress downwardly through the dipleg and over the valve/baffle surface.

Yet another preferred embodiment disclosed herein is a method of fluid catalytic cracking of a hydrocarbon feed comprising:

passing a suspension of a hydrocarbon feed and a fluidized catalyst through a riser conversion zone;

cracking said hydrocarbon feed in said riser conversion zone to produce a mixture, said mixture comprising converted products, unconverted hydrocarbon feed, and spent catalyst;

passing said mixture from the riser conversion zone to at least one cyclone separator having an inlet a gas phase outlet, and a solids outlet;

separating at least a portion of the spent catalyst from the mixture in said at east one cyclone separator;

passing the separated spent catalyst downwardly into a dipleg inlet, said dipleg having an inlet and an outlet, wherein said dipleg inlet is fluidly connected to said cyclone separator solids outlet;

passing the separated spent catalyst through the dipleg to the dipleg outlet located in a catalyst pre-stripping zone, wherein a dipleg valve/baffle is in fluid communication with said dipleg outlet, and wherein said dipleg valve/baffle controls spent catalyst flow through the dipleg and disperses said spent catalyst within a catalyst pre-stripping zone;

contacting said separated spent catalyst with a first stripping gas after contacting of said spent catalyst with the surface of said valve/baffle in the catalyst pre-stripping zone to remove at least a portion of hydrocarbons entrained within the separated spent catalyst;

passing the separated spent catalyst from the catalyst pre-stripping zone to a catalyst stripping zone;

contacting a second stripping gas with the separated spent catalyst in countercurrent flow in the catalyst stripping zone to remove hydrocarbons entrained within the catalyst; and

passing the separated spent catalyst from the catalyst stripping zone to a catalyst regeneration vessel.

Further objects, features and advantages of the present disclosure will be understood by reference to the following drawings and detailed description.

### BRIEF DESCRIPTION OF THE FIGURES

FIG. 1 depicts a dipleg with a flapper valve closed and open.

FIG. 2 depicts a dipleg with a trickle valve closed and open.

FIG. 3 depicts an aerated splash baffle with a built in stripping gas ring. The stripping gas ring is effectively sealed to the splash baffle so that stripping gas is forced into the catalyst above the baffle, rather than escaping underneath the baffle.

FIG. 4 depicts an aerated splash baffle with a built in stripping gas ring. The stripping gas ring is covered with a ledge to protect it from the force of the spent catalyst flow.

FIG. 5 depicts an aerated splash baffle with stripping gas introduced at a single point or a small orifice near the apex, rather than using a stripping gas ring with multiple perforations. The orifice can be non-circular, e.g., a slot or annular slot.

FIG. 6 depicts an aerated splash baffle that enables extra residence time on the baffle. The baffle is shown with a stripping gas ring in the base on the annular extra stripping volume on the baffle. The stripping gas ring has perforations in circular tubing to direct the steam into the dense bed in the annular volume on the baffle.

FIG. 7 depicts an aerated splash baffle for a dipleg with a trickle valve (not shown). Stripping gas may introduced at a single small slot near the baffle apex, below the baffle, or the stripping gas from the dense phase section of the reactor may be allowed to pass through the slot.

FIG. 8 depicts an unaerated splash baffle for a dipleg with a trickle valve (not shown).

FIG. 9 depicts a dipleg that is sealed the valve/baffle. The valve/baffle is in the closed position.

FIG. 10 depicts a dipleg in which the valve/baffle is in the open position,

FIG. 11 graphically depicts stripping efficiency from cold flow FCC stripper tests that were conducted using a rectangular (or 2-D) cold flow model (CFM), with and without a cone-shaped baffle below the bottom of a dipleg, in accordance with the Example below.

### DETAILED DESCRIPTION OF THE PREFERRED EMBODIMENTS

A typical feed to an FCC unit of this disclosure is a gas oil such as a light or vacuum gas oil. Other petroleum-derived feed streams to the FCC unit may comprise a diesel boiling range mixture of hydrocarbons or heavier hydrocarbons such as reduced crude oils. The chemical composition and structure of the feed to the FCC unit will affect the amount of coke deposited upon the catalyst in the reaction zone. Normally, the higher the molecular weight, carbon, heptane insolubles, and carbon/hydrogen ratio of the feedstock, the higher will be the coke level on the spent catalyst. Also, high levels of combined nitrogen, such as found in shale-derived oils, will increase the coke level on spent catalyst. Processing of heavier feedstocks, such as deasphalted oils or atmospheric bottoms from a crude oil fractionation unit (commonly referred to as reduced crude) results in an increase in some or all of these factors and causes an increase in the coke level on spent catalyst. As used herein, the term “spent catalyst” is intended to indicate catalyst employed in the reaction zone which is being transferred to the regeneration zone for the removal of coke deposits. The term is not intended to be indicative of a total lack of catalytic activity by the catalyst particles.

In the FCC unit of this disclosure, the reaction zone, which is normally referred to as a “riser”, due to the widespread use of a vertical tubular conduit (or “riser”), is utilized as the primary reaction zone for the FCC cracking processes. Here, the reaction zone is maintained at cracking conditions typically above about 425° C. (797° F.), more preferably a temperature of from about 480° C. to about 650° C. (896 to 1202° F.), and a pressure of from about 65 to 500 kPa (9.4 to 72.5 psi). The catalyst/oil ratio, based on the weight of catalyst and feed hydrocarbons entering the bottom of the riser, may range up to 20:1 but is preferably between about 4:1 and about 10: 1. The average residence time of catalyst in the riser is preferably less than about 5 seconds. The type of catalyst employed in the process may be chosen from a variety of commercially available catalysts. As utilized in the invention herein, a catalyst comprising a zeolitic component material is preferred.

The FCC process unit of this disclosure in general comprises a reaction zone and a catalyst regeneration zone. This disclosure may be applied to any configuration of reactor and regeneration zone that uses a riser for the conversion of feed by contact with a finely divided fluidized catalyst maintained at an elevated temperature and at a moderate positive pressure. In this disclosure, contacting of catalyst with feed and conversion of feed primarily takes place in the riser. The riser comprises a principally vertical conduit and the effluent of the conduit empties into a reactor vessel, which can include for purposes herein an internal component associated within such reactor vessel. One or more solids-vapor separation devices, for example, at least one cyclone separator, is preferably located within and near of the reactor vessel. The one or more cyclone separators separate the reaction products from a portion of catalyst which is still carried by the vapor stream. One or more conduits vent the vapor from the cyclone separator. After initial separation, the spent catalyst passes through a “dipleg” attached to the lower portion of the cyclone separator and into the dilute phase zone of the reactor. The dilute phase zone allows for rapid disengagement of entrained hydrocarbon vapors in high flux catalyst flows exiting the cyclone dipleg in the reactor vessel. In the invention herein, the bottom of the dipleg (or dipleg outlet) is located in the dilute phase zone, or area, or the FCC reactor. The term “dilute phase” as used herein is intended to indicate a catalyst/gas mixture having a density of less than 320 kg/m³ (20 lbs/ft³), in a similar manner, the term “dense phase” as used herein is intended to mean that the catalyst/gas mixture has a density equal to or more than 320 kg/m³ (20 lbs/ft³). Representative dilute phase operating conditions often include a catalyst /gas mixture having a density of about 8 to 150 kg/m³ (0.5 to 9.4 lbs/ft³).

In a most preferred embodiment of the present invention, cyclone separators (with associated diplegs) are utilized and these cyclone separators are configured in a “closed cyclone” arrangement. In the closed cyclone arrangement, the riser is directly fluidly attached to the cyclones instead of first entering the dilute phase area of the FCC reactor. Here, very quick and immediate separation of the catalyst and hydrocarbon products is made to reduce unwanted continued or secondary cracking reactions, sometimes referred to as “overcracking”. In this configuration, the invention disclosed herein is of primary importance to aid in the quick stripping of hydrocarbons from the spent catalysts to reduce overcracking.

The stripping zone (or “stripper”) in the configuration and processes described herein is located below the dilute phase zone, and is more preferably located below a portion of the dense phase zone of the reactor. After the spent catalyst has passed through the stripping zone, it can be transferred to the reactor vessel or pass through one or more additional stages of stripping.

Once stripped, the spent catalyst flows to a regeneration zone. In the FCC processes herein, spent catalyst is continuously circulated from the reaction zone to the regeneration zone and then again to the reaction zone. The catalyst therefore acts as a vehicle for the transfer of heat from zone to zone as well as providing the necessary catalytic activity. Catalyst which is being withdrawn from the regeneration zone is referred to as “regenerated” catalyst. The catalyst charged to the regeneration zone is brought into contact with an oxygen-containing gas such as air or oxygen-enriched air under conditions which result in combustion of the coke. This results in an increase in the temperature of the catalyst and the generation of a large amount of hot gas which is removed from the regeneration zone and referred to as a flue gas stream. The regeneration zone is preferably operated at a temperature of from about 600° C. to about 800° C. (1112 to 1472° F.).

The catalyst regeneration zone is preferably operated at a pressure of from about 35 to 500 kPa (5.1 to 72.5 psi). The spent catalyst being charged to the regeneration zone may contain from about 0.2 to about 5 weight percent coke. This coke is predominantly comprised of carbon and contains hydrocarbons, as well as sulfur and other elements. The oxidation of coke will produce the common combustion products: carbon dioxide, carbon monoxide, and water, as well as other combustion compounds. As known to those skilled in the art, the regeneration zone may take several configurations, with regeneration being performed in one or more stages. Further variety in the operation of the regeneration zone is possible by regenerating fluidized catalyst in a dilute phase or a dense phase.

In the present invention, although not required, “flapper valves” and/or “trickle valves” can be used at the lower ends of separator cyclone diplegs in the FCC regenerator. These are typically used in order to maintain a predetermined height of catalyst in the dipleg above the valve. However, in the present invention, the use of such dipleg valves, such as flapper or trickle valves, are not required. The cyclone diplegs as used herein may be open ended and such open ends may possess full or restricted cross-sectional areas, or even expanded cross-sectional areas (such as the outlet being cut an angle other than 90° from the axis of the dipleg conduit). Additionally, such dipleg outlets, whether valved or not, may be oriented at any discharge angle that is conducive with the operation of the devices described herein.

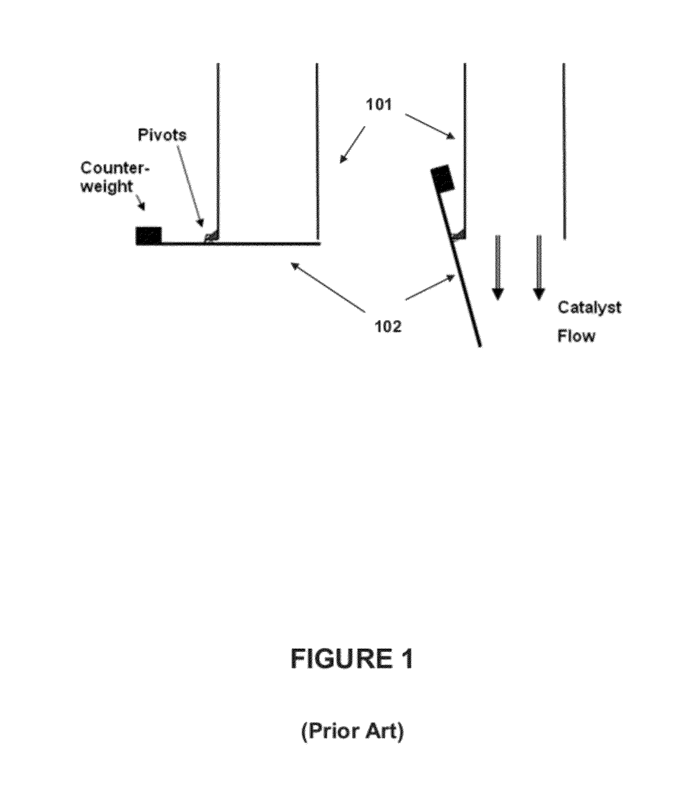

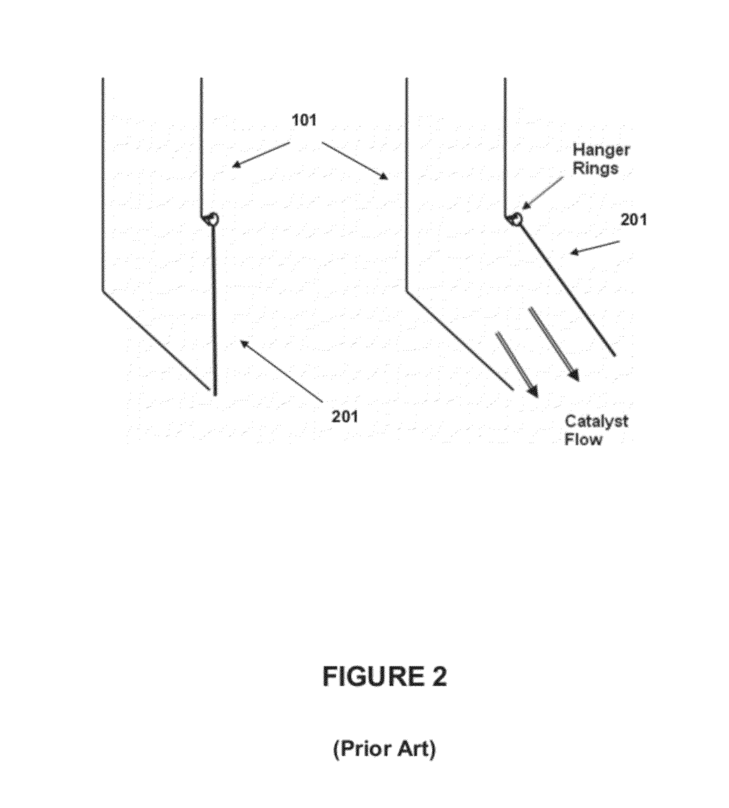

An illustrative flapper valve of the prior art useful in this disclosure is shown in FIG. 1. An illustrative trickle valve of the prior art useful in this disclosure is shown in FIG. 2. The valves are typically hinged about horizontal axes so as to permit them to open when the height of catalyst in the dipleg above the valve exceeds a predetermined value; the weight of catalyst pushes the valve open, permitting the catalyst to be discharged from the dipleg until the biasing on the valve closes it once more when the cycle repeats. In principle, the hinging can be carried out equivalently about a vertical axis with suitable biasing means e.g., a spring, provided for closing the valve, but conventionally a horizontal hinge axis is used with biasing towards the closed position of the valve provided by means of a counterweight on the opposite side of the hinge on the closing plate or simply by the weight of the flapper plate itself. The portion of the valve which closes the bottom of the dipleg may be vertical, horizontal or at any intermediate angle when the valve is in the closed position. The angle selected for the closed position of the valve is generally a matter of Choice and may be determined by the configuration and/or orientation of the dipleg splash baffles disclosed herein.

In one embodiment of this disclosure, below the outlet of a cyclone separator dipleg, a splash baffle is placed which rapidly disperses catalyst exiting the dipleg. Preferably, steam or another aerating gas is piped to the splash baffle, and is injected into the dense phase flow of spent catalyst on top of the baffle. This gives rapid removal of emulsion phase hydrocarbons, together with improved distribution of the descending spent catalyst in the stripper cross section. As used herein, the term “splash baffle”, “dipleg splash baffle”, “dilute phase splash baffle”, “baffle plates” or similar terms herein are equivalents and are meant to describe a baffle plate or baffle plates which are located in the vicinity of at least a portion of the cyclone dipleg outlets and come in direct contact with at least a portion of the catalyst stream exiting the dipleg outlet(s).

As discussed prior, better spent catalyst stripping is important to reducing delta coke and enabling higher conversion of feed to valuable products. Minimizing product hydrocarbon (fluidizing gas) entrainment with high flux of spent catalyst exiting primary cyclone diplegs avoids further non-selective conversion at relatively long (1-2 minutes) stripper residence time. This improves FCC profitability.

The devices of this disclosure, e.g., baffle plates, achieve rapid disengagement of entrained hydrocarbon vapors, especially in high flux catalyst flow exiting primary cyclone diplegs in an FCC reactor vessel. Typically diplegs for negative pressure cyclones are fitted with a suitable trickle valve or flapper valve to prevent backflow of stripping gases into the diplegs which would reduce cyclone efficiency. These valves maintain a head of catalyst in the dipleg. The head pressure overcomes mechanical resistance to force the valve open and discharge spent catalyst into the stripper. Valves on diplegs can be especially useful in preventing backflows during unit startups.

FIG. 1 shows a schematic of a dipleg (101) with a flapper valve (102), where the valve is essentially horizontal when closed. When the valve is open, catalyst drops substantially vertically downward, although the valve (if not completely open) may still affect the flow pattern. FIG. 2 shows a schematic of a dipleg (101) with a trickle valve (201), where the valve hangs essentially vertical when closed. It should be noted that although not shown in FIGS. 1 through 8 herein, the diplegs shown are fluidly attached to a separation device (preferably a “cyclone” or cyclonic separation device) which is located at an orientation above the dipleg as shown in the figures.

In a conventional FCC unit, the catalyst exiting the dipleg drops as a relatively concentrated stream through the dilute phase in the reactor and is eventually flowed into the stripper section, or stripping zone, of the reactor. In the stripping zone, the spent catalyst is typically distributed by shed trays which serve as countercurrent contacting means between descending catalyst and ascending stripping gases. Utilizing the baffle plate devices of this disclosure, catalyst flow is more quickly dispersed and trapped hydrocarbons released in the dilute phase zone of the reactor prior to being trapped in the dense phase zone of the reactor wherein these hydrocarbons are more difficult to remove. The devices of this disclosure also distribute spent catalyst more uniformly in the stripper section thereby improving the overall stripping efficiency of the current processes.

In an embodiment, below the dipleg outlet, and located in the dilute phase of the FCC reactor, a fixed splash baffle is placed in the path of spent catalyst exiting the dipleg and comes into contact with at least a portion of the stream of spent catalyst exiting the dipleg outlet. Preferably, the baffle plate is wider in at least one dimension, preferably at least two dimensions, than the diameter of the dipleg outlet. The baffle plate preferably has a provision for stripping gas (preferably comprising stream) to enter the spent catalyst which is moving across the top of the baffle plate. The baffle plate preferably includes a baffle plate body member having a surface, and one or more apertures located on at least a portion of the surface. Preferably, a countercurrent vapor flow is capable of being directed through the one or more apertures sufficient to remove at least a portion of hydrocarbons entrained within a spent catalyst flow from a dipleg. The at least one baffle plate is sufficient for facilitating release of hydrocarbons entrained within the spent catalyst, and for distributing spent catalyst more uniformly in the catalyst pre-stripping zone and the catalyst stripping zone.

For a dipleg with a flapper valve, or wherein the opening of the outlet of the dipleg is in a substantially horizontal plane, where the catalyst drops more or less straight down from the exit of the dipleg, a preferred baffle configuration is a more or less axisymmetric cone, with a top surface angle of less than 60° to the horizontal, or pyramidal shape. The baffle plate preferably has a configuration sufficient for dispersing a spent catalyst flow from a dipleg. The baffle plate can be made of curved pieces, flat pieces, or a combination. Preferably, the baffle is made in part of a refractory material, particularly a metal (preferably stainless steel), more preferably including an abrasion resistance coating, such as a ceramic composition. The area of the splash baffle herein is preferably more or less under and in the vicinity of the dipleg, and takes the main downward force of the spent catalyst flow, and serves to change or deflect the direction of catalyst flow, preferably to spread the flow at least partly sideways. The descending spent catalyst flows over the baffle surface, e.g., conical surface, which preferably has an orifice or orifices to allow stripping gas into the relatively dense phase spent catalyst flow to provide early stripping of the catalyst. The spent catalyst then flows down into the dilute phase of the reactor and from the dilute phase, flows into the dense phase of the reactor and finally into the stripper section of the reactor located in the dense phase zone where final stripping is completed.

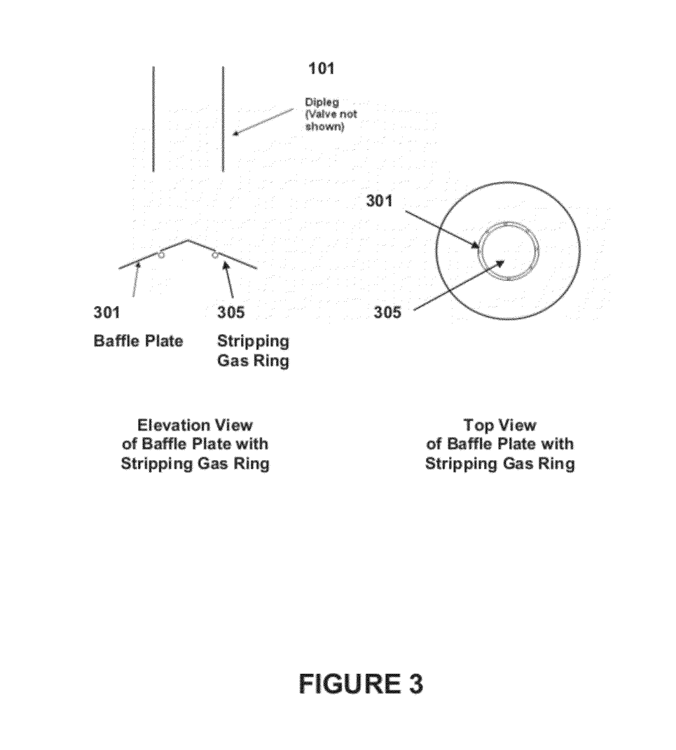

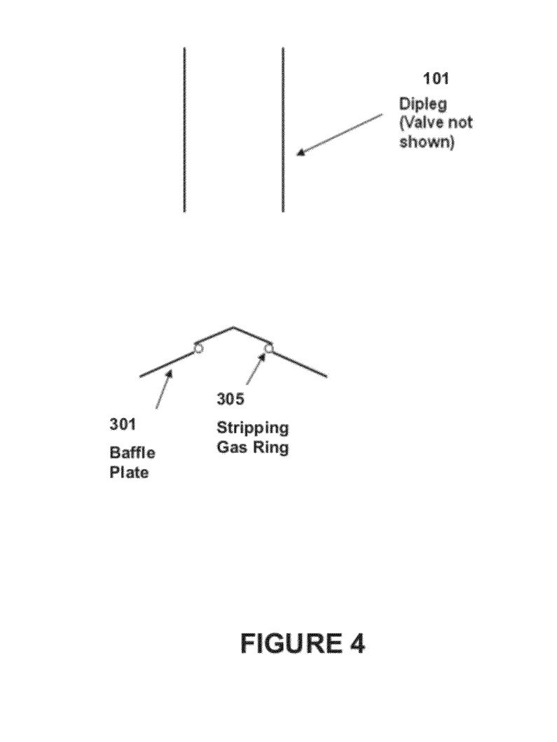

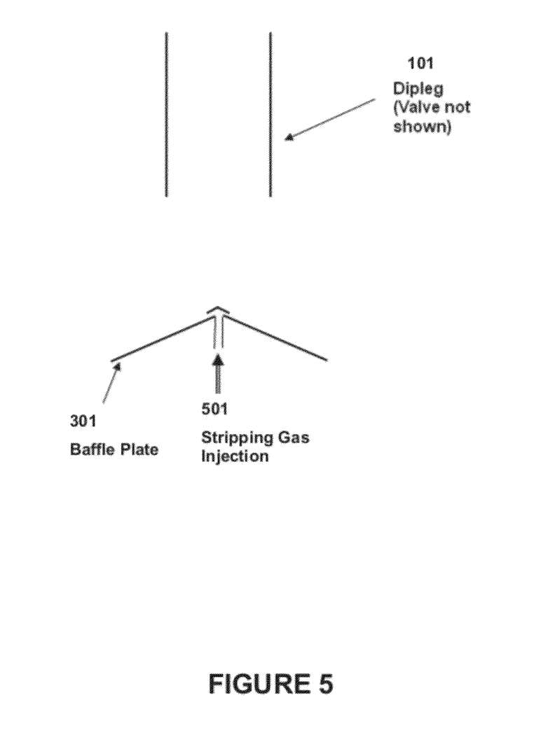

FIGS. 3, 4, and 5 show variations of the splash baffle plate design, with differing details on the stripping gas injection. FIG. 3 illustrates a flat, or single level design of the splash baffle plate (301) along with a stripping gas distributor (305) incorporated into the design and functionality of the baffle plate. As seen here, in the elevation view, the baffle plate (301) is situated below the outlet of the catalyst dipleg (101). FIG. 4 illustrates a similar design as FIG. 4, but wherein a multilevel design of the splash baffle plate (301) is shown along with a stripping gas distributor (305) incorporated into the design and functionality of the baffle plate. As also seen here, in the elevation view, the baffle plate (301) is situated below the outlet of the catalyst dipleg (101). The design shown in FIG. 4 also give additional functionality on allowing the stripping gas below the baffle to have a substantially horizontal radial component to its velocity assisting in improved catalyst distribution and gas contact. FIG. 5 illustrates yet another embodiment incorporating the catalyst dipleg (101) and the splash baffle plate (301) wherein the stripping gas (501) is injected below the baffle with channels through the baffle to allow stripping gas distribution of the surface of the baffle plate (301).

In these designs appropriate sealing (e.g. welding the stripping gas distributor piping to the underside of the baffle, or other means) should be provided, so that the stripping gas issuing from orifices does not have a significant path available to escape underneath the baffle, i.e., the stripping gas is forced into the spent catalyst atop the baffle. The splash baffles may be conical or “domed” in shape with orifices or apertures in the baffle wherein the stripping gas, e.g. steam, is distributed below the baffle, and at least a portion of the stripping gas passes upward through such orifices or apertures and contacts the catalyst being distributed across the top of the splash baffles.

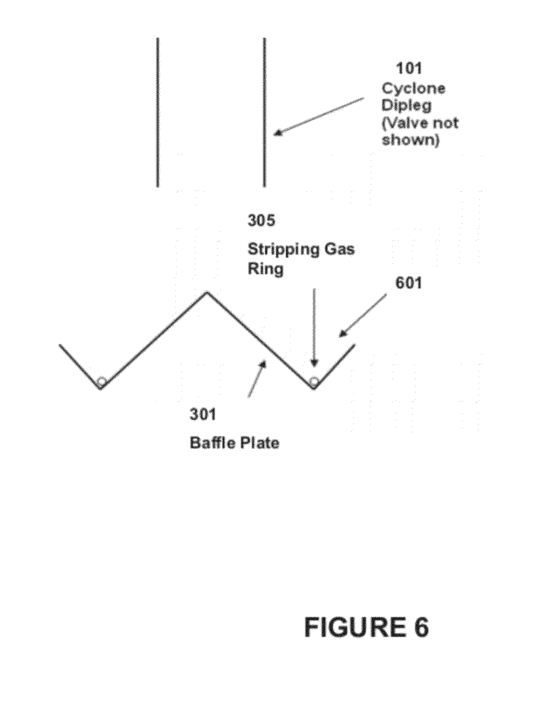

Other baffle plate features, such as extra holes for catalyst drainage or a lip around the baffle for retaining a level of catalyst on the baffle, may be added. For instance, a design is shown in FIG. 6, where an annular volume (601) is provided on top of the baffle plate (301), which gives extra residence time for the catalyst to be stripped. In this case, there is sufficient catalyst dense bed depth atop the baffle that the stripping gas distributor (305) is located above the baffle plate, which also reduces issues with sealing of the stripping gas distributor (or ring) to the baffle.

The baffle designs in FIGS. 3 through 6 are shown for the flapper valve diplegs, or with open vertical dip:legs wherein the flow of the catalyst from the dipleg outlet has a substantially vertical velocity component. These are easier to conceptualize because of the substantial symmetry around a vertical axis. However, similar designs can be utilized wherein the catalyst outlet from the dipleg outlet has a substantial horizontal flow velocity component.

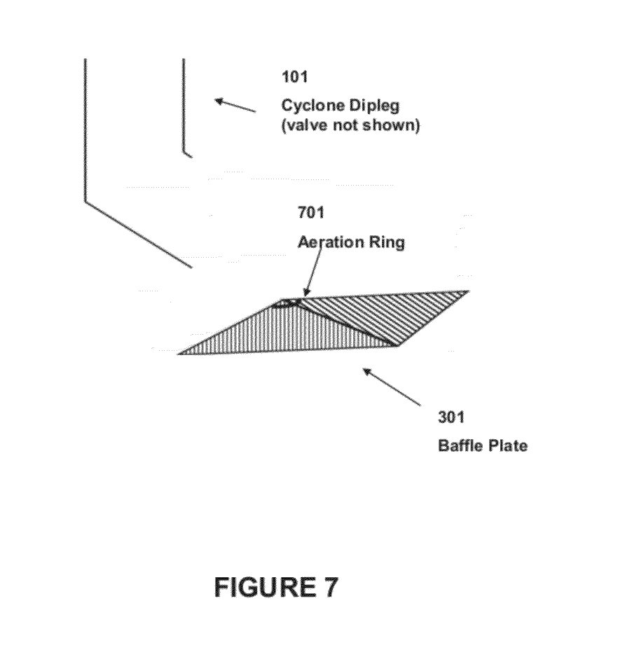

Similar aerated baffles are proposed for diplegs with trickle valves, or can be used with open diplegs, wherein the flow of the catalyst from the dipleg outlet has a non-vertical velocity component. In general, baffle design utilized in these configurations will be offset horizontally from the axis of the dipleg. Those skilled in the art should be able to design useful aerated splash baffles of our invention which will work below a trickle valve. Again, preferably at least one dimension, preferably at least two dimensions, of the baffle plate is larger than the diameter of the dipleg outlet. If the device is substantially conical, domed or pyramidal, etc. in design, it is preferably tilted, with the apex of the cone tilted towards the dipleg, and positioned so that the apex of the cone or similar geometry is close to the center of the catalyst flow that is discharged from the dip:leg. An example of an aerated splash baffle under a trickle valve is shown in FIG. 7. Here, this particular splash baffle (301) is shown in FIG. 7 with a pyramidal shape which includes an aeration ring (701), wherein the splash baffle (301) is in fluid communication with the catalyst dipleg (101) outlet.

The baffle plate can be mounted or supported below the dipleg by any suitable means, for example, by welding. It is preferably positioned directly below the dipleg outlet to allow rapid dispersement of the spent catalyst flow from the dipleg into the pre-stripping zone. Preferably, a stripping gas for “aerating gas”) which is preferably comprised of steam is piped to the splash baffle and is injected through apertures into the dense phase spent catalyst flow on top of the baffle. This provides for rapid removal of emulsion phase hydrocarbons, in addition to improved distribution of the descending spent catalyst flow in the pre-stripping zone. Details of how the mount the splash baffles in place are known by those skilled in the art. In preferred embodiments, the baffle plate is physically attached to the base of the dipleg, e.g., by welded struts.

In other preferred embodiments, the baffle plates are oriented in the FCC reactor such that the linear distance from the bottom of the dipleg outlet to the top of the baffle plate is from 1 to 4 times the equivalent diameter of the dipleg outlet. This limited distance ensures maximum contact of the catalyst with the baffle plate. The term equivalent diameter is well known in the art and is utilized herein to define the distance when the outlet of the dipleg when it is of either a circular or non-circular geometry.

In another preferred embodiment herein, the FCC reactor vessel comprises both primary cyclone separators and secondary cyclone separators and at least one baffle plate is located near the dipleg outlets of each of the primary cyclone separators. Furthermore, in this instance, it is more preferred if the maximum total projected area of the baffles in a plane that is perpendicular to the axis of the FCC reactor is less than 20%, preferably less than 15%, of the cross-sectional area of the FCC reactor as measured in the same plane. As noted here, the splash baffles herein can operate with considerably greater open area available in this dilute phase section of the FCC reactor as compared to shed trays located in the FCC dense phase tripping section which typically only allow for approximately 30 to 70% open cross-sectional area in the FCC reactor.

The flow rate of stripping steam used in these devices may be specified as kg (or kg/hr) of steam fed the aerated baffle per 1000 kg for kg/hr) (2204 lbs) of catalyst exiting the cyclone dipleg. A preferred application is a FCC cyclone dipleg. A preferred range of steam is 0.1 to 1.5 kg (0.22 to 3.31 lbs) steam per 1000 kg (2204 lbs) catalyst, and more preferred is 0.2 to 0.6 kg (0.44 to 1.32 lbs) steam per 1000 kg (2204 lbs) catalyst.

In an embodiment herein, a first stripping gas enters the fluid catalytic cracking unit (or FCC reactor) in the catalyst pre-stripping zone of the FCC reactor vessel and near the baffle plate, while a second stripping gas enters the fluid catalytic cracking unit in the dense phase stripping zone of the FCC reactor vessel. In another embodiment where no additional stripping gas is employed in the vicinity of the baffle plates, the first stripping gas contacting the catalyst near the baffle plates and the second stripping gas utilized are one in the same and both enter the fluid catalytic cracking unit in the dense phase stripping zone in an FCC reactor vessel.

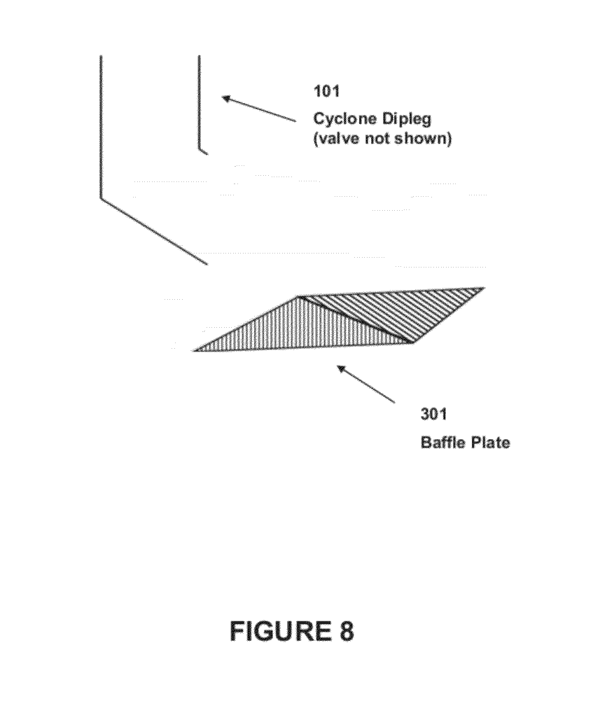

Unaerated splash baffles may also be useful in this disclosure. Splash baffles (aerated or non-aerated) below diplegs are included within this disclosure. With or without the aeration feature, a splash baffle below a dipleg, particularly in conjunction with a trickle valve or a flapper valve, can be useful in dispersing the flow of catalyst from the dipleg. An illustration of a splash baffle below a trickle valve is shown in FIG. 8. Here, this particular splash baffle (301) is shown in FIG. 7 with a pyramidal shape, wherein the baffle is not supplied with an aeration feature wherein the baffle (301) is in fluid communication with the catalyst dipleg (101) outlet.

This disclosure includes a FCC unit that utilizes at least one baffle plate. The FCC unit includes a riser conversion zone, at least one cyclone separator, a dilute phase zone, a dense phase zone, a stripping zone, and a regeneration zone. The riser conversion zone is for passing a suspension of a hydrocarbon feed and a catalyst therethrough and cracking said hydrocarbon feed to produce a mixture. The mixture comprises converted products, unconverted hydrocarbon feed and spent catalyst. The at least one cyclone separator is for separating at least a portion of the spent catalyst from the mixture. The at least one cyclone separator has an upstream end and a downstream end. The cyclone separator has a dipleg attached to the downstream end. In preferred embodiments, the dipleg has at its lower end a valve, e.g., a flapper valve or trickle valve, for controlling the flow of spent catalyst therethrough. The catalyst stripping zone or stripper is for contacting a stripping gas with the spent catalyst to remove at least a portion of hydrocarbons entrained within the catalyst and is located in the dense phase zone of the reactor. The at least one baffle plate is located in the dilute phase zone of the reactor below and in the vicinity of the dipleg outlet, and is contacted by at least a portion of the spent catalyst flowing from the dipleg outlet, and such baffle plate disperses at least a portion of the spent catalyst flow exiting from the dipleg. The stripping zone is for contacting a stripping gas with the spent catalyst to remove hydrocarbons entrained within the spent catalyst. The regeneration zone is for regenerating the spent catalyst.

This disclosure also includes a method for fluid catalytic cracking a hydrocarbon feed. The method includes passing a suspension of a hydrocarbon feed and a catalyst through a riser conversion zone. The hydrocarbon feed is cracked in the riser conversion zone to produce a mixture. The mixture comprises converted products, unconverted hydrocarbon feed, and spent catalyst. The mixture is passed from the riser conversion zone to at least one cyclone separator having an upstream end and a downstream end. The cyclone separator has a dipleg attached to the downstream end. At least a portion of the spent catalyst is separated from the mixture in the at least one cyclone separator. The separated spent catalyst is then passed downwardly into the dipleg. In preferred embodiments, the dipleg has at its lower end a valve, e.g., flapper valve or trickle valve, for controlling the flow of spent catalyst therethrough. The separated spent catalyst is passed from the dipleg to the dilute phase zone of the reactor. The dilute phase zone contains at least one baffle plate located in the dilute phase zone of the reactor below and in the vicinity of the dipleg outlet, and is contacted by at least a portion of the spent catalyst flowing from the dipleg outlet, and such baffle plate disperses at least a portion of the spent catalyst flow exiting from the dipleg. The reactor includes a stripping zone in the dense phase zone of the reactor wherein of a stripping gas is contacted with the separated spent catalyst in countercurrent flow of the spent catalyst to remove at least a portion of hydrocarbons entrained within the spent catalyst. The separated spent catalyst is then passed from the catalyst stripping zone to a catalyst regeneration vessel.

In another embodiment of this disclosure, in place of a flapper valve or trickle valve at the outlet of a cyclone separator dipleg, a combination valve/baffle is placed which rapidly disperses catalyst exiting the dipleg. Preferably, steam or another aerating gas is piped to the valve/baffle, and is injected into the flow of spent catalyst located on top of the valve/baffle. This gives rapid removal of emulsion phase hydrocarbons, together with improved distribution of the descending spent catalyst in the stripper cross section. The combination valve/baffle retains spent catalyst to a predetermined value of the height of spent catalyst in the dipleg when the valve/baffle is in the closed position and releases spent catalyst from the dipleg when the height of spent catalyst in the dipleg exceeds the predetermined value. This valve/baffle is located in the dilute phase zone of the reactor vessel.

An important feature of this disclosure is the replacement of traditional dipleg outlet valves, e.g., trapper valves and trickle valves, with a combination valve and single substantially conical baffle which serves a dual function. The valve/baffle is suspended on opposed counterweighted hangers which allow the top conical section to seat against the dipleg bottom until the catalyst head forces it to open. The descending catalyst then flows over the conical surface preferably which has drilled holes and/or a lip around the periphery. Countercurrent vapor flow facilitates stripping of hydrocarbons from the flowing spent catalyst. The catalyst then flows down into the stripper section where additional stripping of the spent catalyst is performed in the dense phase of the reactor.

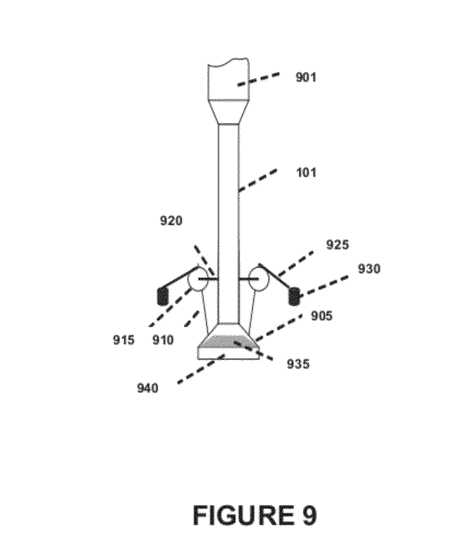

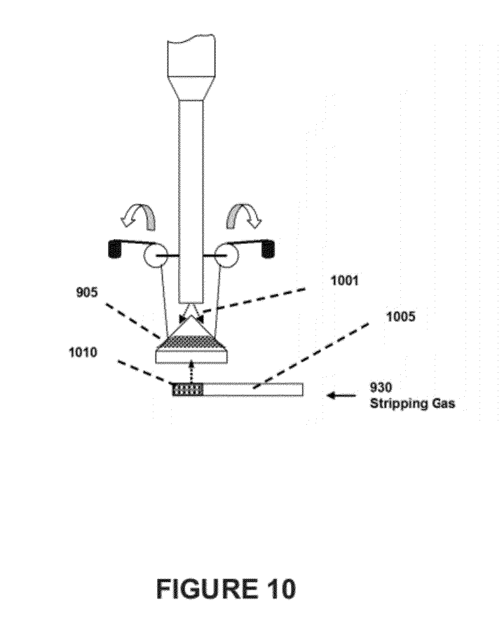

FIGS. 9 and 10 conceptually illustrate this embodiment. FIG. 9 shows the device in its closed position, i.e., the dipleg is sealed by the valve/baffle. FIG. 10 shows the device in its open position as the head of catalyst exceeds the counterweights and the valve/baffle drops down to allow catalyst to flow over the conical surface and descend to the stripper shed deck below.

In the embodiment shown in FIG. 9, a cyclone dipleg (101) is configured attached to the solids outlet of cyclone (901). The installation of the device herein can be in association with either at least one primary reactor cyclone, at least one secondary reactor cyclone, or both. Instead of terminating in an elbow or bent section, in this embodiment, it is preferred that the dipleg (101) is terminated as a straight pipe. At the outlet is configured a substantially conical element (905) with included angle between 90° and 120°. It should be noted that the conical element (905) may alternatively be “domed” (i.e., substantially curved) in shape. For simplicity purposes, when referring to the “conical shed”, “conical valve” or similar herein, it is contemplated to include a domed shape shed or valve. This conical shed is suspended on hangers (910) eccentrically connected to the periphery of rotating disks (915) which are mirror images and diametrically opposed. Disk (915) rotates on an axle supported by bracket (920). Each disk has a lever arm (925) with attached weight (930). When the accumulated catalyst head at the bottom of dipleg (101) reaches sufficient height, the catalyst weight overcomes the counterweight (930) and disk (915) rotates (clockwise or counterclockwise) with the upper tip of hanger rod (910) tracing an arc along the circumference of disk (915) until the conical shed equilibrates at an “open” position as shown in FIG. 10. In this embodiment shown in FIGS. 9 and 10, the element (905) is provided with a series of apertures (935) in the conical surface to allow passage of stripping gas from below to flow upwardly through the spent catalyst (indicated by arrows (1001) in FIG. 10) dispersed and flowing across the surface. A lip (940) is preferentially provided around the periphery of the conical shed surface to facilitate pressure drop across these apertures and thus provide better removal of emulsion hydrocarbons. As shown in FIG. 10, a preferred embodiment is to add a stripping gas sparger (1005) directly below the conical baffle element (905) so as to further improve stripping efficiency. Stripping gas exits via orifices (1010) in sparger (1005) as indicated by the upward pointing arrow.

The valve/baffle device may be designed to handle catalyst flux in the range of 100-150 lbm/ft²-sec. Four hangers are preferred for each dipleg, located 90° apart to ensure reliable, stable operation. Those skilled in the art will recognize the need for erosion-resistant refractory on the conical surface for metal protection. Various hardware modifications and alternative mechanical designs are possible means for suspending, as well as opening and closing the valve/baffle element within the scope of the invention. As an alternate example, counterweights (930) may be integral with lever arms (925). Alternatively, the means for suspending, as well as opening and closing the valve/baffle element (3) may be a simple weight and pulley system without the need for the lever arms (925) as shown in FIGS. 9 and 10. Furthermore, in other alternate embodiments of the means for opening and closing the valve/baffle element (3), the rod hangers (910) and rotating disks (915) might be replaced by spring hangers and/or tension bars with tension set to seat the apex of the conical shed against the beveled dipleg outlet, but elongate, rotate, or bend with increasing catalyst head in the dipleg to open the valve and allow spent catalyst to flow over the surface of the shed.

The valve/baffle utilized in this disclosure includes a valve/baffle body member comprising a substantially conical (or domed) shed having a substantially conical (or domed) shed surface. The conical shed surface comprises a conical seating surface that is complementary to a dipleg seating surface at the lower end of the dipleg. The valve/baffle includes a means for suspending the conical shed on one or more brackets attached to the dipleg, thereby allowing a closed position and an open position. In the closed position, the conical seating surface is seated against the dipleg seating surface, thereby substantially preventing gases from progressing upwardly through the dipleg. In the open position, the conical seating surface is not seated against the dipleg seating surface, thereby permitting spent catalyst to progress downwardly through the dipleg and over the conical shed surface.

In an embodiment, the means for suspending the conical shed on one or more brackets attached to the dipleg includes two or more opposed hangers each connected to the conical shed and each eccentrically connected to the periphery of a different rotating disk. Each rotating disk capable of rotating on an axle supported by the one of more brackets. Each rotating disk has a lever arm attached to weight, thereby forming opposed counterweighted hangers.

In another embodiment, the means for suspending the conical shed on one or more brackets attached to the dipleg includes two or more opposed spring hangers each connected to the conical shed and the one or more brackets. Preferably, the two or more opposed spring hangers are tension set to seat the conical seating surface against the dipleg seating surface, thereby substantially preventing gases from progressing upwardly through the dipleg and, with increasing spent catalyst head in the dipleg, to elongate and unseat the conical seating surface against the dipleg seating surface, thereby permitting spent catalyst to progress downwardly through the dipleg and over the conical shed surface.

This disclosure includes a FCC unit that utilizes at least one valve/baffle. The FCC unit includes a riser conversion zone, at least one cyclone separator, a catalyst pre-stripping zone, a stripping zone, and a regeneration zone. The riser conversion zone is for passing a suspension of a hydrocarbon feed and a catalyst therethrough and cracking said hydrocarbon feed to produce a mixture. The mixture comprises converted products, unconverted hydrocarbon feed and spent catalyst. The at least one cyclone separator is for separating at least a portion of the spent catalyst from the mixture. The at least one cyclone separator has an inlet end, a gas outlet end, and a solids outlet end. The cyclone separator has a dip leg attached to the solids outlet end. The dipleg has at its lower end a valve/baffle for controlling the flow of spent catalyst through the dipleg and for dispersing spent catalyst flow from the dipleg. The catalyst pre-stripping zone is for contacting a stripping gas with the spent catalyst to remove at least a portion of hydrocarbons entrained within the catalyst. The at least one baffle plate is located in the catalyst pre-stripping zone below the valve of the dipleg for dispersing spent catalyst flow from the dipleg. The stripping zone is for contacting a stripping gas with the spent catalyst to remove hydrocarbons entrained within the spent catalyst. The regeneration zone is for regenerating the spent catalyst.

This disclosure includes a method for fluid catalytic cracking a hydrocarbon feed. The method includes passing a suspension of a hydrocarbon feed and a catalyst through a riser conversion zone. The hydrocarbon feed is cracked in the riser conversion zone to produce a mixture. The mixture comprises converted products, unconverted hydrocarbon feed, and spent catalyst. The mixture is passed from the riser conversion zone to at least one cyclone separator having an upstream end and a downstream end. The cyclone separator has a dipleg attached to the downstream end. At least a portion of the spent catalyst is separated from the mixture in the at least one cyclone separator. The separated spent catalyst is then passed downwardly into the dipleg. The dipleg has at its lower end a valve/baffle for controlling the flow of spent catalyst through the dipleg and for dispersing spent catalyst flow from the dipleg. The separated spent catalyst is passed from the dipleg to a catalyst pre-stripping zone. A stripping gas is contacted with the separated spent catalyst, dispersed from the valve/baffle, in countercurrent flow in the catalyst pre-stripping zone to remove at least a portion of hydrocarbons entrained within the spent catalyst. The separated spent catalyst is passed from the catalyst pre-stripping zone to a catalyst stripping zone. A stripping gas is contacted with the separated spent catalyst in countercurrent flow in the catalyst stripping zone to remove hydrocarbons entrained within the catalyst. The separated spent catalyst is then passed from the catalyst stripping zone to a catalyst regeneration vessel.

Various modifications and variations of this disclosure will be obvious to a worker skilled in the art and it is to he understood that such modifications and variations are to be included within the purview of this application and the spirit and scope of the claims.

### EXAMPLE

Cold flow FCC stripper tests were conducted. A rectangular (or 2-D) cold flow model (CFM) was used. The test apparatus had a 4.5 foot wide and 1 foot deep rectangular cross-section and was a ⅕ scale representation of a commercial FCC reactor unit including the dilute phase catalyst dipleg section and dense phase stripping section of the reactor. The base case internals consisted of several rows of stripper sheds which were a scaled representation of the dense phase stripper internals of a commercial FCC unit. FCC catalyst entered the top of the test apparatus from a cyclone dipleg and flowed down through the test apparatus as air flowed upward, as a stripping gas, to simulate stripping steam. The test apparatus was operated at ambient temperature and pressure, using several catalyst flux and stripping gas rates. Helium was injected into the test apparatus to simulate hydrocarbon vapor entering the top of the stripper and the helium that remained at the bottom of the stripper was measured, as an indication of stripping efficiency. The test apparatus was utilized with and without a cone-shaped baffle located below the bottom of the dipleg, but still in the dilute phase area of the reactor. The cone shaped baffle was added per the scope of the present disclosure in an attempt to improve the distribution of the catalyst at the top of the stripper.

With the base stripper baffle configuration as tested, the addition of the cone shaped baffle reduced the amount of un-stripped helium at the bottom of the apparatus from 15% to 12%, at the same catalyst flux and stripping gas rate. This is a substantial increase when it is considered that by the addition of a single dipleg baffle herein (with no addition of stripping gas) there was an improved reduction in un-stripped gas (representing un-stripped hydrocarbons) leaving the bottom of the stripping zone (15%-12%/12%) which equals a 25% overall improved reduction of un-stripped hydrocarbons exiting the bottom of the dense phase stripping zone for the FCC unit. This is a significant and valuable recovery of valuable hydrocarbons in the process, as un-stripped hydrocarbons exiting the bottom of the dense phase stripping zone are lost in the subsequent catalyst regeneration processes.

This is a considerable and unexpected improvement, especially when it is considered that the base case dense phase stripper section used in this cold flow model example contained about 45 shed trays. The addition of just a single dipleg baffle as disclosed herein located in the dilute phase section of the reactor model below the dipleg outlet resulted in a 25% overall decrease in the un-stripped hydrocarbons from the stripping unit.

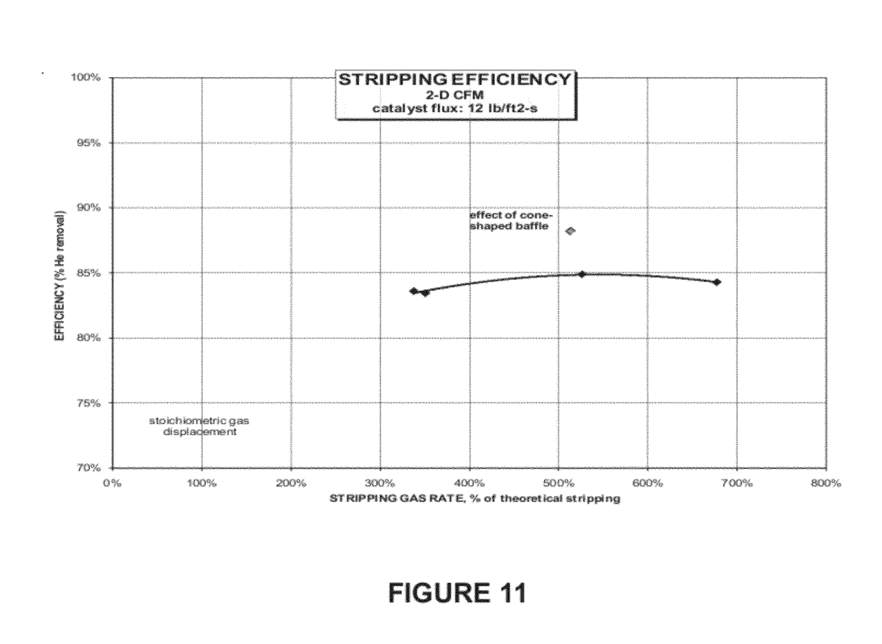

The corresponding stripping efficiency data is shown graphically in FIG. 11. In FIG. 11, the base case prior art (without the dipleg baffle) was run under several rates (e.g., constant catalyst flux but multiple stripping velocities) Which formed the base case curve. The dipleg baffle, an embodiment of the present invention, was tested at one data point at a stripping rate of about 500% of theoretical stripping. The diamond above the base case curve in FIG. 11 shows the increased stripping efficiency due to the conical dipleg baffle.

As used herein, “theoretical stripping” means a volumetric flow rate of stripping gas that is equal to the volumetric flow rate of the void spaces between the catalyst in the stripper. 100% of theoretical stripping means a volume of stripping gas equal to the void space in the catalyst flows through the stripping section in the same amount of time.

What is claimed is:

1. A fluid catalytic cracking unit comprising:
a riser conversion zone for passing a suspension of a hydrocarbon feed and a fluidized catalyst therethrough and cracking said hydrocarbon feed to produce a mixture, said mixture comprising converted products, unconverted hydrocarbon feed and spent catalyst;
at least one cyclone separator, in fluid connection with the riser conversion zone, for separating at least a portion of the spent catalyst from the mixture, said at least one cyclone separator having an inlet a gas phase outlet, and a solids outlet;
a dipleg comprising a dipleg inlet in fluid connection with the cyclone separator solids outlet, and a dipleg outlet;
a catalyst pre-stripping zone in fluid connection with the dipleg outlet for contacting a first stripping gas with the spent catalyst to remove at least a portion of hydrocarbons entrained within the catalyst;
at least one baffle plate located in the catalyst pre-stripping zone near the dipleg outlet for dispersing spent catalyst flow from the dipleg;
a dense phase stripping zone, in fluid connection with the catalyst pre-stripping zone, for contacting a second stripping gas with the spent catalyst to remove hydrocarbons entrained within the spent catalyst; and
a regeneration zone, in fluid connection with the dense phase stripping zone, for regenerating the spent catalyst.

2. The fluid catalytic cracking unit of claim 1 wherein the baffle plate is located in a dilute phase section of an FCC reactor vessel and the average density within the dilute phase section of the FCC reactor vessel is less than 320 kg/m³ and the average density within the dense phase stripping zone of the FCC reactor vessel is greater than 320 kg/m³.

3. The fluid catalytic cracking unit of claim 2 wherein the at least one baffle plate comprises:
a baffle plate body member having a surface; and
one or more apertures located on at least a portion of the surface.

4. The fluid catalytic cracking unit of claim 3 wherein a countercurrent vapor flow is capable of being directed through the one or more apertures sufficient to remove at least a portion of hydrocarbons entrained within a spent catalyst flow from the dipleg outlet.

5. The fluid catalytic cracking unit of claim 2 wherein said baffle plate body member has a configuration sufficient for dispersing a spent catalyst flow from the dipleg outlet.

6. The fluid catalytic cracking unit of claim 2 wherein the baffle plate body member comprises a refractory material.

7. The fluid catalytic cracking unit of claim 1 wherein the baffle plate is sufficient for facilitating release of hydrocarbons entrained within the spent catalyst, and for distributing spent catalyst within said catalyst pre-stripping zone and said catalyst stripping zone.

8. The fluid catalytic cracking unit of claim 1 wherein at least one dimension of the baffle plate is larger than the diameter of the dipleg outlet,

9. The fluid catalytic cracking unit of claim 1 wherein the at least one baffle plate has an axisymmetric conical shape, a domed shape or a pyramidal shape.

10. The fluid catalytic cracking unit of claim 1 wherein the dipleg outlet is attached to a trickle valve or a flapper valve.

11. The fluid catalytic cracking unit of claim 1 wherein the first stripping gas and the second stripping gas are the same and both enter the fluid catalytic cracking unit in the dense phase stripping zone in an FCC reactor vessel.

12. The fluid catalytic cracking unit of claim 2 wherein the first stripping gas enters the fluid catalytic cracking unit in the catalyst pre-stripping zone of an FCC reactor vessel and near the baffle plate, and the second stripping gas enters the fluid catalytic cracking unit in the dense phase stripping zone of the FCC reactor vessel.

13. The fluid catalytic cracking unit of claim 1 wherein the linear distance from the bottom of the dipleg outlet to the top of the baffle plate is from 1 to 4 times the equivalent diameter of the dipleg outlet.

14. The fluid catalytic cracking unit of claim 2 wherein the FCC reactor vessel comprises both primary cyclone separators and secondary cyclone separators and at least one baffle plate is located near the dipleg outlets of each of the primary cyclone separators.

15. The fluid catalytic cracking unit of claim 14 wherein the maximum total projected area of the baffles in a plane that is perpendicular to the axis of the FCC reactor is less than 20% of the cross-sectional area of the FCC reactor as measured in the same plane.

16. A method of fluid catalytic cracking of a hydrocarbon feed comprising:
passing a suspension of a hydrocarbon feed and a fluidized catalyst through a riser conversion zone;
cracking said hydrocarbon feed in said riser conversion zone to produce a mixture, said mixture comprising converted products, unconverted hydrocarbon feed, and spent catalyst;
passing said mixture from the riser conversion zone to at least one cyclone separator having an inlet a gas phase outlet, and a solids outlet;
separating at least a portion of the spent catalyst from the mixture in said at least one cyclone separator;
passing the separated spent catalyst downwardly into a dipleg inlet, said dipleg having an inlet and an outlet, wherein said dipleg inlet is fluidly connected to said cyclone separator solids outlet;
passing the separated spent catalyst through the dipleg to the dipleg outlet located in a catalyst pre-stripping zone, said catalyst pre-stripping zone containing at least one baffle plate located near the dipleg outlet;
contacting at least a portion of said separated spent catalyst with said baffle plate thereby dispersing at least a portion of said separated spent catalyst contacting said baffle plate within said catalyst pre-stripping zone;
contacting said separated spent catalyst with a first stripping gas after contacting of said spent catalyst with said baffle plate in the catalyst pre-stripping zone to remove at least a portion of hydrocarbons entrained within the separated spent catalyst;
passing the separated spent catalyst from the catalyst pre-stripping zone to a catalyst stripping zone;
contacting a second stripping gas with the separated spent catalyst in countercurrent flow in the catalyst stripping zone to remove hydrocarbons entrained within the catalyst; and
passing the separated spent catalyst from the catalyst stripping zone to a catalyst regeneration vessel.

17. The method of claim 16 wherein the baffle plate is located in a dilute phase section of an FCC reactor vessel and the average density within the dilute phase section of the FCC reactor vessel is less than 320 kg/m^{s} and the average density within the catalyst stripping zone of the FCC reactor vessel is greater than 320 kg/m³.

18. The method of claim 17 wherein the baffle plate comprises:
a baffle plate body member having a surface; and
one or more apertures located on at least a portion of the surface.

19. The method of claim 18 wherein at least a portion of said first stripping gas is directed through the one or more apertures sufficient to remove at least a portion of hydrocarbons entrained within the separated spent catalyst flow from the dipleg outlet.

20. The method of claim 16 wherein the first stripping gas and the second stripping gas are comprised of steam.

21. The method of claim 17 wherein the distribution locations within the FCC reactor vessel for the first stripping gas and the second stripping gas are different and at least a portion of the first stripping gas is distributed into the FCC reactor vessel in the vicinity of and below the baffle plate in the dilute phase section of the reactor vessel, and the at least a portion of the first stripping gas is distributed into the FCC reactor vessel in the catalyst stripping zone of the FCC reactor vessel.

22. The method of claim 16 wherein the conditions in the riser conversion zone include a temperature from about 480° C. to about 650° C. (896 to 1202° F.), a pressure of from about 65 to 500 kPa (9.4 to 72.5 psi), a catalyst/oil ratio of about 4:1 and about 10:1, and wherein the average residence time of the fluidized catalyst in the riser is less than about 5 seconds.

23. A fluid catalytic cracking unit comprising:
a riser conversion zone for passing a suspension of a hydrocarbon feed and a fluidized catalyst therethrough and cracking said hydrocarbon feed to produce a mixture, said mixture comprising converted products, unconverted hydrocarbon feed and spent catalyst;
at least one cyclone separator, in fluid connection with the riser conversion zone, for separating at least a portion of the spent catalyst from the mixture, said at least one cyclone separator having an inlet, a gas phase outlet, and a solids outlet;
a dipleg inlet in fluid connection with the cyclone separator solids outlet, and a dipleg outlet;
a dipleg valve/baffle in fluid communication with said dipleg outlet for controlling spent catalyst flow through the dipleg and dispersing said spent catalyst within a catalyst pre-stripping zone;
the catalyst pre-stripping zone in fluid connection the dipleg outlet for contacting a stripping gas with the spent catalyst to remove at least a portion of hydrocarbons entrained within the catalyst;
a dense phase stripping zone, in fluid connection with the catalyst pre-stripping zone, for contacting a stripping gas with the spent catalyst to remove hydrocarbons entrained within the spent catalyst; and
a regeneration zone, in fluid connection with the dense phase stripping zone, for regenerating the spent catalyst.

24. The fluid catalytic cracking unit of claim 23 wherein the dipleg valve/baffle comprises:
a valve/baffle body member comprising a having a conical or domed surface, said valve/baffle surface comprising a seating surface that is complementary to the seating surface of the dipleg outlet; and
a means for suspending the valve/baffle from the dipleg, thereby allowing a closed position and an open position; wherein, in the closed position, the valve/baffle seating surface is seated against the dipleg outlet seating surface, thereby substantially preventing gases from progressing upwardly through the dipleg; and wherein, in the open position, the valve/baffle seating surface is not seated against the dipleg outlet seating surface, thereby permitting spent catalyst to progress downwardly through the dipleg and over the valve/baffle surface.

25. A method of fluid catalytic cracking of a hydrocarbon feed comprising:
passing a suspension of a hydrocarbon feed and a fluidized catalyst through a riser conversion zone;
cracking said hydrocarbon feed in said riser conversion zone to produce a mixture, said mixture comprising converted products, unconverted hydrocarbon feed, and spent catalyst;
passing said mixture from the riser conversion zone to at least one cyclone separator having an inlet a gas phase outlet, and a solids outlet;
separating at least a portion of the spent catalyst from the mixture in said at least one cyclone separator;
passing the separated spent catalyst downwardly into a dipleg inlet, said dipleg having an inlet and an outlet, wherein said dipleg inlet is fluidly connected to said cyclone separator solids outlet;
passing the separated spent catalyst through the dipleg to the dipleg outlet located in a catalyst pre-stripping zone, wherein a dipleg valve/baffle is in fluid communication with said dipleg outlet, and wherein said dipleg valve/baffle controls spent catalyst flow through the dipleg and disperses said spent catalyst within a catalyst pre-stripping zone;
contacting said separated spent catalyst with a first stripping gas after contacting of said spent catalyst with the surface of said valve/baffle in the catalyst pre-stripping zone to remove at least a portion of hydrocarbons entrained within the separated spent catalyst;
passing the separated spent catalyst from the catalyst pre-stripping zone to a catalyst stripping zone;
contacting a second stripping gas with the separated spent catalyst in countercurrent flow in the catalyst stripping zone to remove hydrocarbons entrained within the catalyst; and
passing the separated spent catalyst from the catalyst stripping zone to a catalyst regeneration vessel.

26. The method of claim 25 wherein the dipleg valve/baffle comprises:
a valve/baffle body member comprising a conical or domed surface, said valve/baffle surface comprising a seating surface that is complementary to the seating surface of the dipleg outlet; and
a means for suspending the valve/baffle from the dipleg, thereby allowing a closed position and an open position; wherein, in the closed position, the valve/baffle seating surface is seated against the dipleg outlet seating surface, thereby substantially preventing gases from progressing upwardly through the dipleg; and wherein, in the open position, the valve/baffle seating surface is not seated against the dipleg outlet seating surface, thereby permitting spent catalyst to progress downwardly through the dipleg and over the valve/baffle surface.
